(19) United States
(12) Patent Application Publication
(10) Pub. No.: US 2026/0005865 A1
(43) Pub. Date: Jan. 1, 2026

(54) PRIVACY-PRESERVING LOCATION VERIFICATION SYSTEM AND METHOD

(71) Applicant: ÖNDER LEVENTOGLU, IZMIR (TR)

(72) Inventor: ÖNDER LEVENTOGLU, IZMIR (TR)

(21) Appl. No.: 19/317,999

(22) Filed: Sep. 3, 2025

(51) Int. Cl. H04L 9/32; H04W 12/63

(52) U.S. Cl. CPC H04L 9/3234; H04L 9/3221; H04L 9/3297; H04W 12/63

(57) ABSTRACT

A privacy-preserving location verification system computes distance to venue coordinates locally on a user device, maps the distance to discrete proximity categories comprising at least three categories, and generates a coordinate-free digitally signed attestation containing only category information without coordinates, distances, or any encrypted, hashed, obfuscated, or otherwise reversible representation of geographic coordinates. A verification server validates the signature and derives proximity trust solely from the category, being unable to reconstruct coordinates due to the many-to-one mapping where multiple distinct locations produce identical attestations. The system never transmits coordinates in any form. Embodiments include trusted execution environment isolation, multi-modal positioning, zero-knowledge proofs, and differential privacy.

### CROSS-REFERENCE TO RELATED APPLICATIONS

This application is related to U.S. patent application Ser. No. 19/315,565, filed Aug. 31, 2025, entitled “System and Method for Real-Time Online Review Fraud Detection Using Fraud-Aware Selective Attention with Multi-Tier Verification,” and to applications by the same inventor entitled: “Blockchain Anchoring System for Immutable Review Records,” “Multi-Tier Stance Clarity Verification System,” and “Distributed Trust Score Calculation System,” which may be filed separately. The identified titles are provided for notice; incorporation by reference applies only to applications having a serial number and filing date.

### STATEMENT REGARDING FEDERALLY SPONSORED RESEARCH OR DEVELOPMENT

Not applicable.

### FIELD OF THE INVENTION

The invention relates to location verification and, more particularly, to systems and methods that verify user presence near a venue without transmitting or storing precise geographic coordinates, including embodiments that employ secure hardware, succinct zero-knowledge proofs, differential privacy, and multi-modal positioning.

### BACKGROUND OF THE INVENTION

Conventional presence checks (raw GPS uploads, IP geolocation, manual photos, public “check-ins”) either expose precise location or lack cryptographic assurance. Spoofing and replay are common. Privacy frameworks discourage persistent collection of exact coordinates.

Industry analyses report significant economic impact from interactions where user presence cannot be reliably verified, including review integrity, delivery confirmation, insurance claims, and attendance workflows. Cryptographic, coordinate-free proximity verification has been identified as a potentially effective mitigation across these categories.

A need exists for proximity verification that (i) never transmits exact coordinates, (ii) provides cryptographic integrity and freshness, (iii) operates indoors/outdoors, and (iv) offers quantifiable privacy guarantees.

The present invention differs from existing approaches that: (i) transmit identifiers enabling cross-session tracking; (ii) require server-side processing of actual coordinates; (iii) record location data on public or permanent ledgers; (iv) correlate social or behavioral signals to infer location; or (v) require deployment of venue-specific hardware infrastructure. The present invention's coordinate non-transmission architecture represents a fundamental departure from these approaches.

Unlike systems that transmit coordinates then degrade precision server-side, the present invention never transmits coordinates in any form, whether encrypted, hashed, encoded, or obfuscated. The server receives only categorical proximity values from which coordinate reconstruction is mathematically infeasible due to the lossy nature of the transformation.

Related art references (non-admission). By way of background, various systems disclose geofencing or crowd-sourced location reporting, including without limitation: U.S. Pat. No. 9,479,920 (Apple Inc., power management in crowd-sourced lost-and-found); U.S. Pat. No. 8,971,930 B2 (geofencing system and method); U.S. Pub. No. 2013/0045753 A1 (geo-fence entry/exit notifications); U.S. Pub. No. 2023/0069458 A1 (geofence tracking with encrypted geospatial index and hashed device location identifiers); U.S. Pat. No. 9,357,348 B2 (locating tracking devices via crowd-sourced reports); U.S. Pat. No. 8,018,329 B2 (location event conveyance with geo-fence activation); U.S. Pat. No. 12,244,606 B2 (trusted program reporting of location-related events); U.S. Pat. No. 11,175,407 B2 (geofence crossing-based control); U.S. Pat. No. 11,393,323 B2 (tracking devices, methods and systems); U.S. Pub. No. 2018/0192243 A1 (dynamic geofence); and U.S. Pat. No. 9,420,426 B2 (inferring a current location based on location history). These references transmit coordinates or coordinate-derived values (including encrypted/hashed forms) and/or perform server-side geofence evaluation; by contrast, embodiments herein transmit only categorical, coordinate-free attestations that structurally omit coordinates, distances, or any reversible representation thereof.

### SUMMARY OF THE INVENTION

A user device locally computes distance to venue coordinates, maps it to a discrete proximity category, and emits a coordinate-free, digitally signed attestation. A server verifies signature/freshness and computes a proximity trust value using only the category.

Embodiments include: (A) grid-ring ZK membership proofs (succinct, non-interactive) that hide the grid cell; (B) secure-hardware signing and remote attestation; (C) multi-modal positioning with sensor fusion; (D) differential privacy (DP) randomized response with server-side calibration; (E) replay protection, nonce caches, and key rotation; and (F) optional short-range beacon corroboration.

### BRIEF DESCRIPTION OF THE DRAWINGS

FIG. 1 is a system architecture diagram showing a user device, server, venue database, and optional anchoring components.

FIG. 2 is a flowchart illustrating the device-side attestation flow.

FIG. 3 is a diagram showing grid rings and succinct ZK membership verification.

FIG. 4 is a flowchart depicting the server verification pipeline including signature, freshness, nonce cache, and scoring modules.

FIG. 5 is a block diagram illustrating multi-modal positioning with sensor fusion.

FIG. 6 is a timeline diagram showing key lifecycle and rotation.

FIG. 7 is a flow diagram illustrating differential-privacy randomized response and calibration.

FIG. 8 is a state diagram showing battery-aware sampling states.

FIG. 9 is a proximity pipeline overview diagram showing device to TEE distance computation to category selection to signed attestation to server verification, with an explicit coordinates-zeroized callout at the TEE boundary.

FIG. 10 is a privacy-set illustration showing many-to-one mapping from geographic area to categories where area A with resolution r yields approximately A divided by r squared indistinguishable points per category.

FIG. 11 is a migration diagram showing transition from coordinate-based systems to categorical attestations with legacy client/server with lat/lon to on-device TEE shim producing categories to signed categorical attestation to verification server, with coordinates discarded post-derivation.

### DEFINITIONS

Categorical proximity: mapping of a computed distance to a discrete bin.

Proximity attestation: a signed, coordinate-free payload including at least venue identifier, category, timestamp, and nonce.

Succinct ZK proof: a non-interactive proof (e.g., SNARK-class) that verifies constraints/membership without revealing the witness.

Ringed grid set: a public set of geographic grid cells grouped by distance ranges around a venue.

Trusted execution environment (TEE): secure hardware (or equivalent facility) for key generation, storage, and signing.

TEE exit definition. As used herein, “exiting the TEE” means returning from secure-world execution to non-secure execution (e.g., a world switch on ARM TrustZone, enclave exit on Intel SGX, or equivalent). Zeroization of coordinate values occurs before the return boundary.

Proximity trust value: a numerical score derived from the proximity category, representing confidence in user presence near the venue.

Attested edge derivation service: a compute service operated by the same controller or its contracted processor within the same trust domain, providing in-memory categorization with no persistent storage, enforcing remote attestation (e.g., TPM 2.0 quote, SGX/SEV/TDX, or equivalent TEE evidence) before processing, and emitting non-coordinate audit proofs of deletion. The service forwards only coordinate-free signed categories to the verification server.

### DETAILED DESCRIPTION OF EXEMPLARY EMBODIMENTS

### System Model and Threat Assumptions

The adversary may read, modify, and replay network traffic; attempt device spoofing; and correlate repeated attestations. The server is honest-but-curious (verifies proofs but should learn no coordinates). The device is not assumed to be root-secure unless a TEE is present.

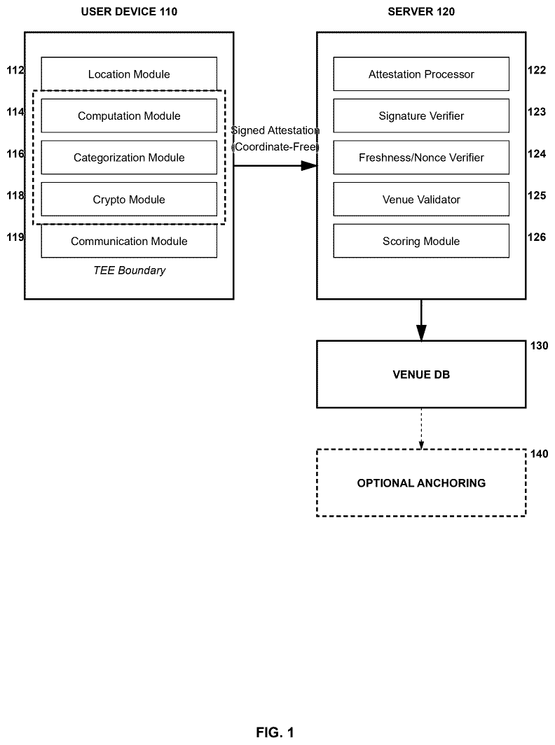

### Architecture (FIG. 1)

Referring to FIG. 1, a user device 110 includes: (i) location module 112; (ii) computation module 114 (distance); (iii) categorization module 116 (discrete binning with uncertainty handling); (iv) crypto module 118 (key management, signing, optional remote attestation); and (v) communication module 119.

A server 120 includes: attestation processor 122; signature verifier 123; freshness/nonce verifier 124; venue validator 125 (DB 130); scoring module 126; and optional anchoring 140 (hash-only digests).

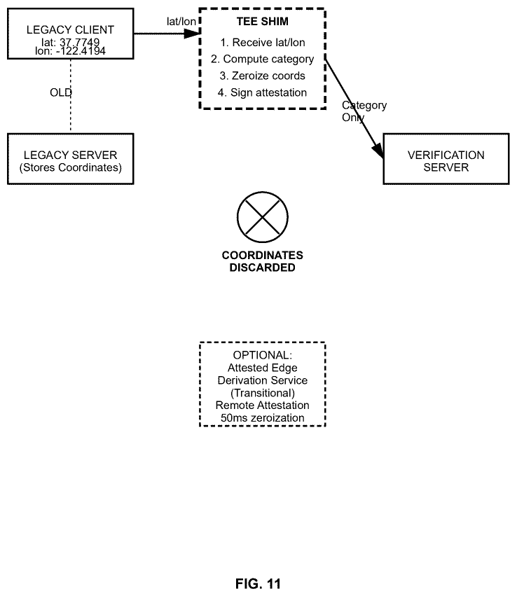

Migration path (FIG. 11, non-limiting). Referring to FIG. 11, existing coordinate-based platforms integrate a thin client-side TEE shim that derives a proximity category on-device and emits a signed categorical attestation. During a transitional period for devices lacking a TEE, a controller-operated attested edge derivation service (as defined in 0027a) MAY be used with the following constraints: (i) coordinates are accepted only in volatile memory; (ii) categorization executes immediately upon receipt; (iii) coordinates are zeroized within 50 ms and never written to disk, logs, or analytics; (iv) only the coordinate-free signed category is forwarded to the verification server; (v) hardware/VM remote attestation evidences isolation prior to processing; and (vi) monitoring emits audit events that exclude coordinates and prove zeroization occurred (e.g., countersigned deletion receipts). Once TEE coverage is sufficient, the edge path is disabled by policy, and only on-device derivation remains.

### Mathematical Preliminaries

### Distance Computation

Great-circle (Haversine): For latitude/longitude (phi,lambda) in radians, venue (phi2,lambda2), device (phi1,lambda1):

Delta phi equals phi2 minus phi1, Delta lambda equals lambda2 minus lambda1 a equals sine squared of (Delta phi divided by 2) plus cosine phi1 times cosine phi2 times sine squared of (Delta lambda divided by 2) c equals 2 times arctangent2 of (square root of a, square root of (1 minus a)), d equals R times c with Earth radius R (e.g., approximately 6,371 km). Unless otherwise specified, geographic coordinates are expressed in the WGS-84 reference frame.

Ellipsoidal (Vincenty, iterative) may be used for higher fidelity; implementations bound iterations and fall back to Haversine on non-convergence.

Fallback when fewer than two positioning sources are available: the device reports an UNKNOWN proximity category with a reduced trust score, preventing false proximity claims when location confidence is insufficient. This behavior is policy-configurable and does not alter the coordinate-free property of the attestation.

### Uncertainty-Aware Categorization

Let the device's 2-D localization error be isotropic Gaussian with std. dev. sigma (meters). The radial error r follows Rayleigh: F(r) equals 1 minus e to the power of (negative r squared divided by (2 times sigma squared)). For a category threshold T, the probability of being within T is P_T equals 1 minus e to the power of (negative T squared divided by (2 times sigma squared)).

Given thresholds 0 less than T1 less than T2 less than T3 less than . . . , posterior category probabilities are computed and the category is selected as argmax or used to compute an expected trust (soft scoring) without disclosing coordinates.

### Proximity Categories and Mapping

Default non-limiting thresholds: AT_VENUE (less than 100 m), NEARBY (100 m to less than 5 km), REGIONAL (5 to less than 25 km), REMOTE (greater than or equal to 25 km). Thresholds are configurable and may adapt to sigma. The number of categories may vary by implementation, with embodiments supporting at least three categories and specific implementations using exactly four categories as enumerated above.

### Proximity Attestation: Data Model & Canonicalization

### Canonical Payload (CBOR or Equivalent):

Attestation { version: u8, venue_id: bytes, // canonical string/UUID proximity_category: u8,
// enum timestamp: u64, // Unix millis nonce: bytes16..32, // random device_id_pseudo?:
bytes, // salted hash or MAC output key_id?: bytes8..16, // rotation zk_proof?: bytes, //
optional succinct proof ring_id?: bytes, // optional: venue ring set ID epsilon?: float, //
optional: DP parameter format_tag?: bytes2 // optional: public format tag }

Deterministic canonicalization. Attestations use deterministic canonical serialization (e.g., CTAP2 canonical CBOR or JCS for JSON). The signature covers DS_CONTEXT∥canonical_bytes. Unknown future fields, if present, are included in the canonicalization and therefore within the signature, preserving forward-compatibility without weakening integrity. The field venue_id MUST be globally unique (UUIDv4 or namespaced UUIDv5) to prevent collisions in multi-tenant deployments. The optional format_tag is public, passed through by verifiers, and recorded in audit logs to aid interoperability and infringement detection; it does not affect verification semantics.

Canonicalization worked example (non-limiting). DS_CONTEXT equals “urn:com.cirs.loc.att.v1” (UTF-8). For JSON, use JCS: lexicographic key ordering, UTF-8, no insignificant whitespace, deterministic number formatting. For CBOR, use CTAP2 canonical form: map keys sorted by major/minor type and numeric value (e.g., keys 0 . . . 10 ordered 0, 1, 2, . . . , 10). Example (diag): {0:1,1:h′8a27 . . . 01′,2:0,3:1736356123456,4:h′9f3c . . . 3dd′}; signature input is DS_CONTEXT∥canonical_bytes.

Device pseudonym options: (a) Salted hash: device_id_pseudo equals H (device_id∥salt), salt fresh per attestation; or (b) OPRF/MAC keyed by an ephemeral key (not linkable across sessions). Venue coordinates and ring commitments are distributed from a signed registry; the server verifies signatures prior to use.

Signature domain separation. A context string (e.g., “urn:com.cirs.loc.att.v1”) is prepended to the serialized bytes to prevent cross-protocol attacks. If a ZK proof is omitted or invalid, the system accepts or rejects based on policy using categorical attestations only.

Domain-separation versioning. DS_CONTEXT contains a protocol identifier and version (e.g., “urn:com.cirs.loc.att.v1”). Version increments are backward-compatible and do not alter the coordinate-free property of the attestation.

### Key Management, Signing & Remote Attestation

Device keys are generated/stored in a TEE when available; otherwise in a software keystore with additional security measures. Software keystore security measures include, but are not limited to: (i) rate-limited signing operations to prevent bulk attestation generation; (ii) monotonic anti-rollback counters to prevent replay of old key states; (iii) measured boot with attestation gating to verify system integrity before key access; (iv) constant-time cryptographic operations to prevent timing side-channels; and (v) mandatory certificate pinning for all network communications. Signing uses widely deployed algorithms (e.g., ECDSA-P256; other public-key schemes are usable). Alternative signature schemes, including post-quantum, are supported without changing the protocol.

Quantum-resistant configuration. In embodiments anticipating quantum computing threats, the system implements hybrid signatures combining classical elliptic curve (ECDSA-P256) with lattice-based schemes (Dilithium3, NIST Level 3). The attestation carries both signatures: sig_classical equals Sign_ECDSA (SK_c, M) and sig_quantum equals Sign_Dilithium (SK_q, M), where M is the canonicalized attestation. Verification requires both: Verify_ECDSA (PK_c, M, sig_classical) AND Verify_Dilithium (PK_q, M, sig_quantum) equals true. This configuration provides 128-bit classical security and NIST Level 3 post-quantum security. The combined signature size increases to approximately 2,420 bytes (ECDSA: 64 bytes, Dilithium3: 2,356 bytes) with verification time under 3 ms on contemporary mobile processors.

Hardware security implementations. Preferred embodiments utilize hardware-backed key storage meeting Common Criteria EAL4+ or equivalent. Examples include: (i) ARM TrustZone with Secure Element (Android 7+); (ii) Apple Secure Enclave Processor (iPhone 5S+); (iii) Intel SGX with Platform Services Enclave; (iv) Qualcomm Secure Processing Unit (SPU); or (v) TPM 2.0 with Platform Configuration Registers. When available, the TEE provides: isolated execution, secure boot attestation, anti-rollback counters, and hardware random number generation per NIST SP 800-90B.

Cryptographic agility. The attestation may carry a ciphersuite identifier negotiating signature and hash algorithms (e.g., ECDSA-P256/SHA-256, Ed25519/SHA-512, Dilithium3/SHA3-256, SPHINCS+−SHAKE). Verifiers advertise supported suites; algorithm agility does not change protocol semantics.

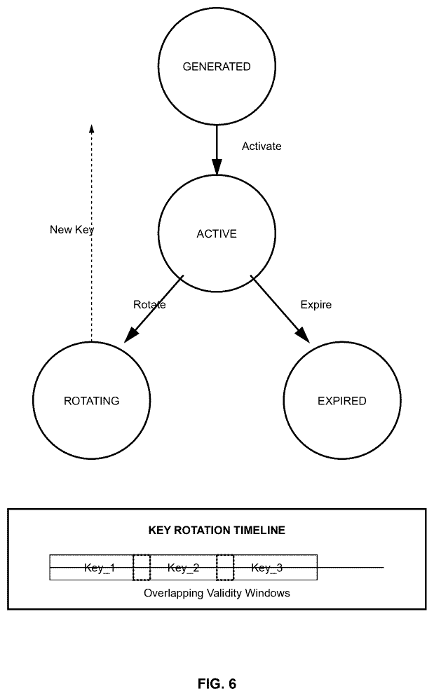

Key rotation. Referring to FIG. 6, each attestation may carry key_id. The server maintains verifiers for overlapping windows and may anchor a hash of the key material or certificate chain.

Remote attestation (optional). A manufacturer-signed token binds the public key to secure hardware state (e.g., code hash, protection level). The server verifies the token and records evidence without learning coordinates. Attestations may include a reference to the remote-attestation evidence or certificate chain to enable offline verification.

Transport security. Network communication between device and server is protected using TLS 1.3 or higher; implementations may employ certificate pinning and mutual authentication to mitigate downgrade and interception attacks.

Transport cipher guidance. Cipher suites SHOULD prefer AEAD with forward secrecy. Session resumption ticket lifetimes are bounded to reduce replay surface.

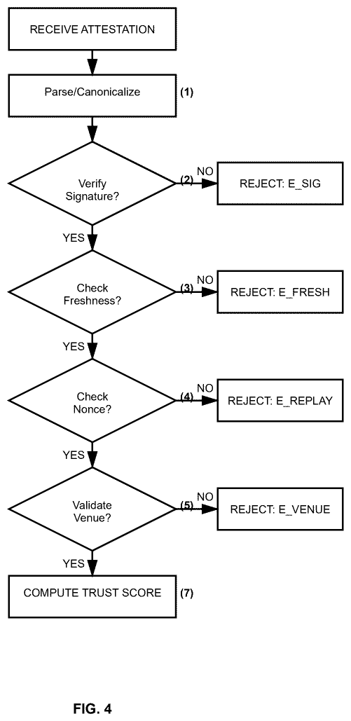

### Server Verification & Replay Protection (FIG. 4)

Referring to FIG. 4, the server verification pipeline comprises the following steps: (1) parse/canonicalize; (2) verify signature; (3) deny if timestamp outside freshness window; (4) deny if nonce observed within the window; (5) validate venue_id in DB; (6) if present, verify ZK proof against published commitments; (7) compute proximity trust value from the category (optionally calibrated for DP). The server's clock is authoritative; devices with drift exceeding the freshness window result in rejection. Attestations outside the freshness window or with repeated nonces are rejected without scoring. Venue coordinates and ring commitments are accepted only if their signatures verify against the signed registry. Non-limiting example: Delta equals 300 seconds with acceptance of {E minus 1, E, E plus 1}.

Distributed replay defense at scale. Nonce caches may use (counting) Bloom filters with false-positive probability p approximately equals (1 minus e to the power of (negative k times n divided by m)) to the power of k for m bits, k hash functions, n inserts; implementations select k approximately equals (m divided by n) times natural log of 2 to minimize p. Caches can be horizontally sharded via consistent hashing of nonce values to maintain window coverage across servers.

Bloom filter operation and rollover (non-limiting). Target FPR less than or equal to 0.001 with expected inserts n per freshness window Delta. Example sizing: for 10 million attestations/hour and Delta equals 5 minutes, n approximately equals 833,333; choose m approximately equals 12 million bits and k approximately equals 7 to 10 hash functions (optimal k approximately equals (m divided by n) times natural log of 2). The implementation uses a counting Bloom filter scoped to the freshness window and rolls/decays entries as the window advances to prevent saturation; shards are rotated independently to avoid cache thrash.

Time Sources and Epoch Binding. Devices attempt time synchronization using, in order, a satellite-derived time source, a network time source, and a cellular network time source. Let the epoch length be Delta. The device computes E equals floor of timestamp divided by Delta; the server accepts attestations bound to E and, to accommodate drift, may accept {E minus 1, E, E plus 1} subject to the freshness window and policy.

Authenticated time sources. Network time may be authenticated using Network Time Security (NTS for NTP). Where unavailable, verifiers may accept Roughtime-style signed timestamps or bounded TLS handshake time as fallback, subject to policy.

Registry operations (rollover and revocation). The signed registry supports key rollover via versioned signing keys and revocation via certificate-revocation lists or an authenticated status endpoint; servers reject venue data signed with revoked or superseded keys.

Registry transparency log. The signed venue registry may be mirrored to an append-only transparency log (Merkle-tree based). Servers verify inclusion and consistency proofs before accepting new registry states, enabling public verification of venue entries, key rollovers, and revocations.

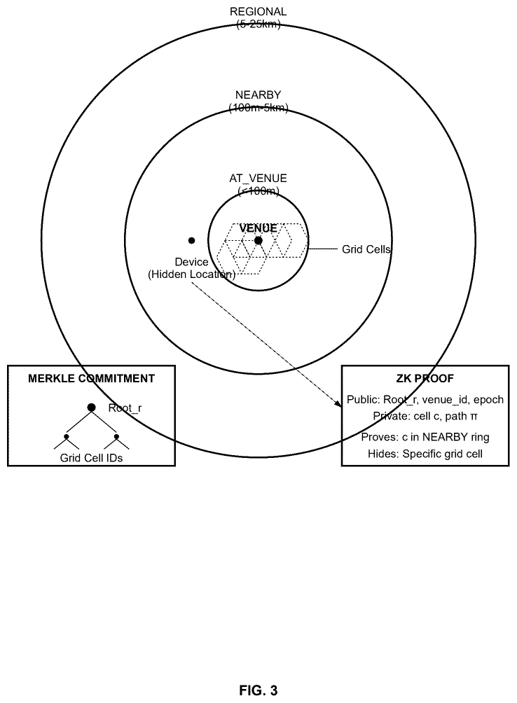

### Grid-Ring ZK Membership (FIG. 3)

Referring to FIG. 3, the grid-ring zero-knowledge membership proof operates as follows:

Gridding. Map coordinates to a grid index (e.g., hexagonal H3 or rectangular geohash). Rings correspond to distance bands (inner/middle/outer/regional).

Publishing. For each ring, the platform publishes a commitment Root_r (e.g., Merkle root over sorted cell IDs with domain separation).

Witness. The device computes its private grid cell c and its Merkle path pi to Root_r.

Succinct proof. A SNARK circuit verifies (public inputs: Root_r, venue_id, epoch; private witness: c, pi) that VerifyMerklePath (c, pi, Root_r) equals true and that c is derived from the device's coordinates and the chosen grid system; it binds to an epoch to mitigate replay. Public parameters (SRS) are verifier-only and may be generated via a widely used ceremony; the circuit binds the venue commitment and epoch; security level lambda is configurable with soundness at least 2 to the power of negative lambda. Non-limiting proving/verification backends include PLONKish circuits over BLS12-381 or Pallas/Vesta; verification keys are versioned and bound to the ring_id.

Non-limiting implementation example: field arithmetic over BLS12-381; Merkle tree depth d equals 24 supporting up to 16 million grid cells; constraint complexity 2 times 10 to the 4th power to 5 times 10 to the 4th power gates; server verification under 1 ms on a 2.4 GHz processor.

Proof generation. The device generates the proof using the witness (grid cell c and Merkle path pi) with respect to the public inputs. The proof size is approximately 192 bytes for BLS12-381 based systems, with generation time under 2 seconds on mobile devices and verification time under 10 milliseconds on standard servers.

Proof-size note (non-limiting). Implementations may optionally employ standard recursive succinct-proof techniques to reduce proof size; this is an engineering choice and is not required for basic operation.

### Differential Privacy

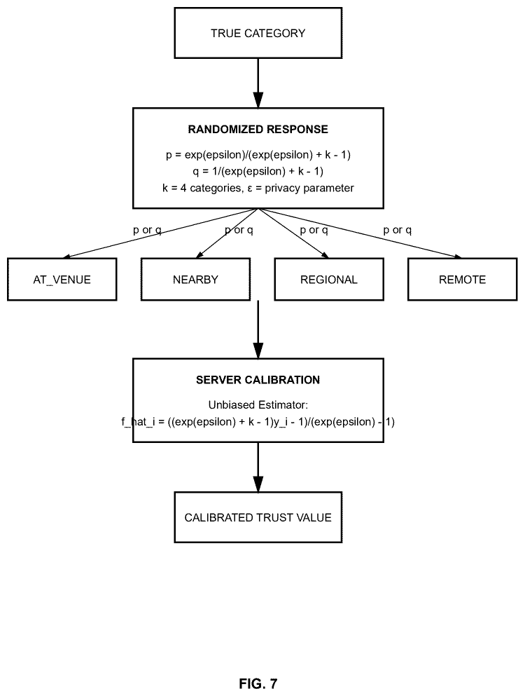

Referring to FIG. 7, differential privacy is implemented through k-ary randomized response over categories. Let k be the number of categories and epsilon greater than 0 the privacy parameter.

Device rule. Report the true category with probability p equals e to the power of epsilon divided by (e to the power of epsilon plus k minus 1); otherwise report one uniformly among the other k minus 1 categories with probability q equals 1 divided by (e to the power of epsilon plus k minus 1) each.

Unbiased estimator. For observed frequency y_i of category i, an unbiased estimator of the true frequency f_i is f_hat_i equals ((e to the power of epsilon plus k minus 1) times y_i minus 1) divided by (e to the power of epsilon minus 1).

Calibration. The server maps the calibrated proximity vector to a trust value (e.g., expected Gp) while preserving local DP guarantees.

Composition. For multiple reports per user, an effective privacy budget may be tracked using standard composition theorems; the system can enforce a per-user cumulative epsilon bound as a policy constraint.

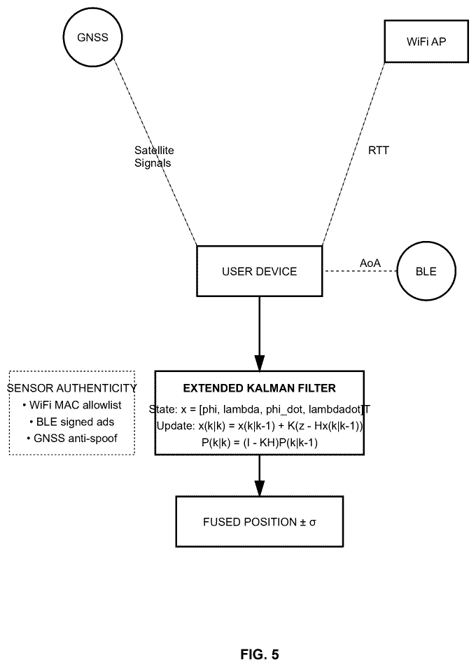

### Multi-Modal Positioning & Sensor Fusion (FIG. 5)

Referring to FIG. 5, the system employs multiple positioning signals: Satellite navigation (GNSS), Wi-Fi timing (e.g., RTT), and radio direction-finding (e.g., AoA).

Urban canyon and total signal failure. When multipath or occlusion degrades position confidence below a policy threshold, or when all positioning sources are unavailable, the device MUST emit either (i) an UNKNOWN category with a signed reason code indicating insufficient confidence, or (ii) no proximity attestation at all, per deployment policy. The system MUST NOT up-classify to a positive category in these conditions. If venue-registered short-range beacons are available and authenticated, they may elevate confidence without revealing coordinates.

Sensor authenticity metadata. When available, measurements include authenticity metadata (e.g., Wi-Fi RTT FTM responder MAC allow-lists; BLE beacons with signed advertisements). Verifiers cross-check these identifiers against the signed registry to reduce spoofing.

State model (Extended Kalman Filter example). State x equals phi, lambda, phi_dot, lambda_dot transposed. Motion update x_k given k minus 1 equals F times x_k minus 1 given k minus 1 plus w, w follows normal distribution with mean 0 and covariance Q. Measurement models: GNSS range (noise R_gnss); Wi-Fi RTT to range rho equals c times Delta t divided by 2 (c: speed of light), Jacobian H_wifi; AoA bearing theta, Jacobian H_aoa. Update: K equals P_k given k minus 1 times H transposed times (H times P_k given k minus 1 times H transposed plus R) inverse, x_k given k equals x_k given k minus 1 plus K times (z minus H times x_k given k minus 1), P_k given k equals (I minus K times H) times P_k given k minus 1. For signal provenance and spoofing resistance of inputs used by the EKF, see sensor authenticity metadata above.

Example tuning. Process and measurement covariances Q and R are selected to reflect motion and sensor noise characteristics; typical values are on the order of 10 to the negative 2nd power to 10 to the 0 power for position states and scale with reported sensor accuracy.

### Optional Short-Range Corroboration

Detection of venue-registered short-range beacons (e.g., BLE) can elevate confidence (AT_VENUE_CONFIRMED) without revealing coordinates; beacon IDs are validated against venue DB.

### Coordinate Handling & Zeroization

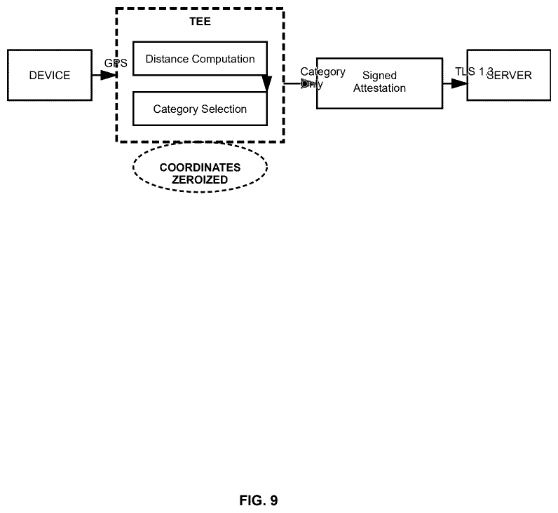

Referring to FIG. 9, coordinates are retained only in volatile memory for local computation. Implementations delete or overwrite them immediately after categorization. In managed runtimes, buffers are pinned and wiped; in native runtimes, memset_s/equivalent constant-time wipes are used, avoiding compiler elision.

Non-limiting TrustZone example: coordinates reside in secure-world memory; categorization is performed in a secure monitor call; a constant-time memset_s executes before world switch back to the non-secure world. End-to-end isolation time is less than 5 ms on representative ARMv8-A systems.

Memory-safety hardening. Implementations may enable memory tagging (e.g., ARM MTE) and pointer authentication (PAC). Sensitive buffers are page-pinned and marked no-swap where feasible to reduce leakage; zeroization uses constant-time routines.

### Security Properties and Implementation MUSTs

Integrity. Digital signatures bind the attestation values.

Freshness/anti-replay. Timestamps plus nonce cache prevent replay within a freshness window.

Non-linkability. Per-attestation salts or ephemeral pseudonyms make cross-session correlation difficult.

Non-disclosure. Coordinates and exact distances are never transmitted; ZK proofs hide grid cells.

Composability. Optional DP and ZK can be used independently.

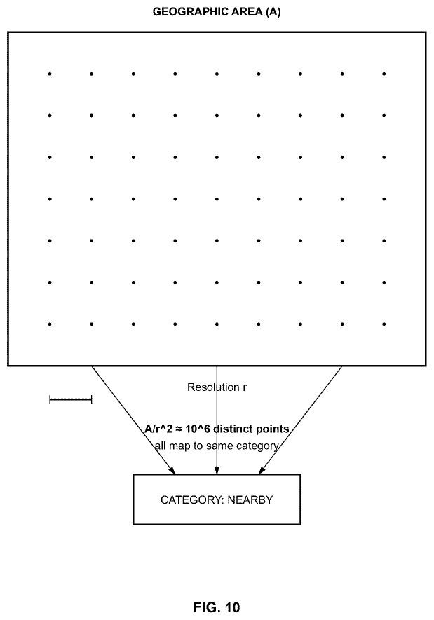

Privacy analysis. Referring to FIG. 10, the transformation from continuous coordinates to discrete categories represents a many-to-one mapping where multiple geographically distinct locations produce identical attestations. For a category spanning area A with resolution r, approximately A divided by r squared distinct coordinates map to the same output, making coordinate reconstruction from the attestation underdetermined. This property holds regardless of computational resources available to an adversary. For example, the NEARBY category (100 m-5 km radius) encompasses approximately 78 km squared containing potentially millions of distinct coordinate pairs that all map to the same category value.

Mathematical guarantee (non-limiting). Let S be the set of all points mapping to category c. An observer of an attestation containing c learns at most that the true location x is an element of S. If the cardinality of S is greater than or equal to M with near-uniform prior over S, then posterior entropy satisfies H (X given c) is greater than or equal to log base 2 of M. Implementations select thresholds so that the cardinality of S is large in typical urban and suburban deployments.

Side-channel & keystore hardening (MUSTs). Implementations perform cryptographic operations in constant time where applicable and employ anti-rollback protections for key storage such that older key states cannot be restored to bypass rotation or policy.

Data minimization & retention policy. Servers retain only verification-necessary metadata (e.g., attestation hash, verification result, key_id, ring_id, format_tag, reason code) for a policy-bounded duration; ephemeral nonce caches expire after the freshness window. No raw coordinates or derived distances are stored.

Consensus signatures (optional). In multi-party scenarios, threshold signatures may be employed where t-of-n parties must cooperate to produce a valid attestation. This prevents single-point compromise while maintaining the coordinate-free property.

Additional security measures. The system may implement rate limiting per device identifier, certificate transparency for key management, and hardware attestation chains. These measures operate orthogonally to the core proximity verification and do not affect the coordinate-free guarantee.

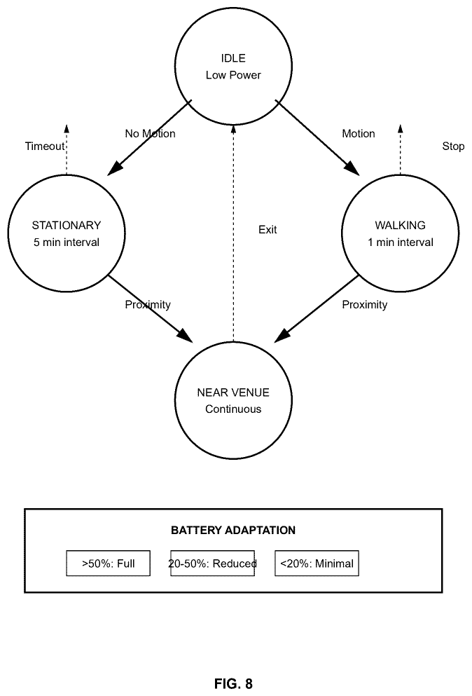

### Battery-Aware Operation (FIG. 8)

Referring to FIG. 8, sampling and proof cadence adapt to motion state (stationary/walking/near venue) with batching and location caching. Fusion accuracy targets and thresholds scale with remaining battery.

### Pseudocode Summaries

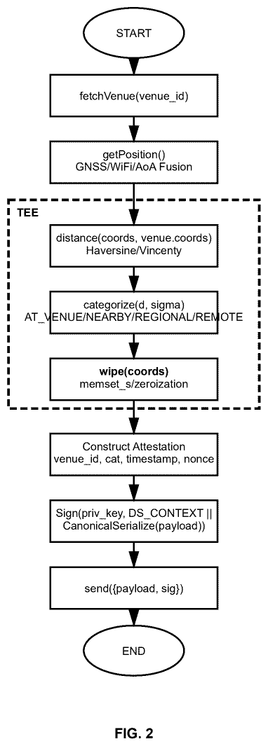

### Device (FIG. 2):

venue = fetchVenue(venue_id) coords = getPosition( ) // GNSS/Wi-Fi/AoA fusion d =
distance(coords, venue.coords) // Haversine/Vincenty cat = categorize(d, sigma) //
thresholds plus uncertainty payload = { version, venue_id, cat, now( ), nonce( ),
device_id_pseudo: pseudonymize(device_id, fresh_salt), key_id, epsilon?, zk_proof?,
ring_id?, format_tag? } sig = Sign(priv_key, DS_CONTEXT | | CanonicalSerialize(payload))
wipe(coords) send({payload, sig})

### Server (FIG. 4):

verifySig(pub_key(payload.key_id), DS_CONTEXT | | CanonicalSerialize(payload))
checkFreshness(payload.timestamp) // server clock authoritative
checkNonce(payload.nonce) // reject repeats within window assert
venueExists(payload.venue_id) // and verify signed registry if payload.zk_proof:
verifyMembership(payload.zk_proof, root_for(payload.ring_id)) score =
scoreFromCategory(payload.category, epsilon=payload.epsilon)
log(format_tag=payload.format_tag) // pass-through for audit return score

Error handling & audit schema. Verification outcomes emit explicit reason codes: OK, E_SIG, E_FRESH, E_REPLAY, E_REGISTRY, E_ZK, E_POLICY. Audit records contain: attestation hash, server timestamp, reason code, key_id, ring_id, ciphersuite id, format_tag. Records exclude coordinates or precise distances.

### Advantages (Privacy by Design)

Reduced data-in-transit: transmitted payloads exclude precise coordinates and distances; only categorical or proof artifacts are sent.

Reduced data-at-rest: servers persist no precise location data; ephemeral nonce caches expire within policy windows.

Attack-surface reduction: on-device computation/local zeroization minimizes exposure of raw coordinates; domain separation and signed registry verification prevent cross-protocol misuse and tampering.

Provable privacy: optional succinct ZK membership and differential privacy provide formal guarantees without operationally revealing location.

### BEST MODE

Preferred: ECDSA-P256 keys generated in a TEE; ringed grid sets published as Merkle roots; succinct SNARK membership proofs; freshness windows on the order of minutes; local DP with epsilon in the range 0.3, 1.0.

### INDUSTRIAL APPLICABILITY

Applicable to review platforms, delivery verification, access control, logistics checkpoints, insurance/risk workflows, and similar privacy-sensitive presence checks.

Technical improvements over prior art. The invention provides concrete technical improvements including: reduced network bandwidth through coordinate elimination; prevention of location tracking through cryptographic mechanisms; indoor verification capability through multi-modal sensor fusion; elimination of server-side coordinate storage; privacy-by-design architecture; and optional quantum-resistant security. These represent technical optimizations rather than business method improvements.

### NO ADMISSION OF PRIOR ART

Techniques in the Background are provided for context and are not an admission that they constitute prior art.

### SEQUENCE LISTING

Not applicable.

1. A computer-implemented method for privacy-preserving location verification, comprising: (a) within a trusted execution environment (TEE) of a user device, obtaining device and venue coordinates, computing a distance, mapping the distance to a proximity category, and zeroizing coordinate values from volatile memory before exiting the TEE; (b) constructing a coordinate-free proximity attestation including a venue identifier, the proximity category, a timestamp, and a cryptographically random nonce, the proximity attestation excluding geographic coordinates, distance values, and any encrypted, hashed, obfuscated, or otherwise reversible representation of geographic coordinates; deterministically canonicalizing the attestation with a domain-separation context string (DS_CONTEXT), and signing the canonicalized attestation within the TEE using a hardware-protected private key; and (c) transmitting the signed attestation over Transport Layer Security (TLS) 1.3 or higher to a verification server that verifies the signature, enforces anti-replay using a Bloom filter configured with a false-positive rate less than 0.001, and computes a proximity trust value without accessing, storing, or reconstructing geographic coordinates; zeroizing, prior to any world switch out of the TEE, all coordinates and all intermediate values derived therefrom; canonicalizing the attestation payload using canonical CBOR or JCS-JSON and a versioned DS_CONTEXT to ensure domain separation

2. The method of claim 1, wherein the device coordinates are obtained from at least two of: GNSS sensors, Wi-Fi round-trip time measurements, and Bluetooth Low Energy angle-of-arrival sensors.

3. The method of claim 1, wherein the plurality of discrete proximity categories comprises exactly four categories: AT_VENUE (less than 100 m), NEARBY (100 m to 5 km), REGIONAL (5 km to 25 km), and REMOTE (25 km or greater).

4. The method of claim 1, wherein the canonicalization uses CTAP2 canonical CBOR or JCS-JSON with lexicographic key ordering and deterministic number encoding, and the DS_CONTEXT is a versioned protocol identifier.

5. The method of claim 1, wherein authenticated time is obtained via Network Time Security (NTS) for NTP or via a Roughtime-style signed timestamp, and the server accepts attestations bound to an epoch E within a policy window consisting of E minus 1, E, and E plus 1.

6. The method of claim 1, wherein the server validates the venue identifier against a signed venue registry and verifies inclusion and consistency proofs in an append-only transparency log prior to accepting registry updates.

7. The method of claim 4, further comprising obtaining authenticated time via a signed timestamp and validating the venue identifier against a signed registry.

8. The method of claim 1, further comprising providing a succinct zero-knowledge proof that a device location, mapped to a grid cell, is a member of a venue-published ringed grid set without revealing the specific grid cell.

9. The method of claim 1, wherein the device identifier uses a per-attestation salt that is cryptographically generated and discarded immediately after use, preventing cross-session linkability.

10. The method of claim 1, wherein the TLS connection bounds session resumption ticket lifetimes.

11. The method of claim 1, wherein the nonce-replay Bloom filter is horizontally sharded via consistent hashing of nonce values across servers.

12. The method of claim 1, wherein the proximity category is represented as an enumerated integer and the ciphersuite identifier negotiates signature and hash algorithms without altering protocol semantics.

13. A system for privacy-preserving location verification, comprising: (a) a user device having a trusted execution environment (TEE) configured to: compute distance from device coordinates to venue coordinates; map the distance to a proximity category; zeroize coordinate values before exiting the TEE; construct and sign a coordinate-free proximity attestation containing only the proximity category, venue identifier, timestamp, and nonce; and (b) a verification server configured to: receive the signed attestation over TLS 1.3 or higher; verify the signature and enforce anti-replay using a Bloom filter with false-positive rate less than 0.001; and compute a proximity trust value based solely on the proximity category; a canonicalization component to render the attestation payload in canonical CBOR or JCS-JSON with a versioned DS_CONTEXT for domain separation; a freshness component to bind the attestation to authenticated time with acceptance limited to an epoch identifier E within {E−1, E, E+1}

14. The system of claim 13, wherein the server obtains authenticated time via NTS for NTP or a Roughtime-style signed timestamp and accepts attestations bound to an epoch E within a policy window consisting of E minus 1, E, and E plus 1.

15. The system of claim 13, wherein the TLS connection bounds session resumption ticket lifetimes.

16. The method of claim 1, wherein the zeroization occurs within a bounded time window of completion of the categorization step.

17. The method of claim 1, wherein the trusted execution environment provides hardware-enforced memory isolation with a trust boundary that prevents coordinate values from being accessible to the non-secure execution environment.

18. The method of claim 1, wherein the nonce-replay Bloom filter is configured with parameters including a plurality of hash functions and a bit-to-item ratio sufficient to achieve a false-positive rate of 0.001 or lower.

19. The method of claim 1, wherein zeroization of coordinate values occurs prior to any world switch to the non-secure execution environment.

20. A computer-implemented method for verifying location with information-theoretic privacy, comprising: transforming, on a user device, a continuous coordinate space into discrete proximity categories such that each category C contains at least M distinguishable locations and the posterior entropy satisfies H (X given C) is greater than or equal to log base 2 of M; constructing a coordinate-free attestation that includes only the category and excludes geographic coordinates, distance values, and any encrypted, hashed, obfuscated, or otherwise reversible representation of geographic coordinates; digitally signing the attestation on the user device; and transmitting the signed attestation to a verification server that verifies the signature and computes a proximity trust value without accessing or reconstructing geographic coordinates.
